(19) United States
(12) Patent Application Publication
(10) Pub. No.: US 2005/0171879 A1
(43) Pub. Date: Aug. 4, 2005

(54) Interactive counter service system for banks and similar finance organizations

(76) Inventor: Li-Lan Lin, San Chung City (TW)

Correspondence Address: PRO-TECHTOR INTERNATIONAL, 20775 Norada Court, Saratoga, CA, 95070-3018, US

(21) Appl. No.: 10/770,649

(22) Filed: Feb. 2, 2004

(51) Int. Cl. G06F 17/60

(52) U.S. Cl. 705/35; 705/39

(57) ABSTRACT

An interactive counter service system for banks and similar finance organizations mainly includes a touch-screen module, a counter-terminal module, and network communicating equipment. The touch-screen module is mounted at counters of the banks to serve as an interface via which a customer may select one or more desired transactions provided by the bank and input required data via a magnetic strip reader or a card reader of the touch-screen module. The counter-terminal module enables a counter clerk to synchronously receive and process the data input by the customer and provide on-line business consultation to help the customer to complete the selected transaction. The interactive counter service system effectively improves the interactive relation between the customer and the bank and thereby upgrades the service quality of the bank.

### FIELD OF THE INVENTION

The present invention relates to an interactive counter service system for banks and similar finance organizations, and more particularly to an interactive counter service system that enables a counter clerk to interact with a customer in handling different transactions, such as depositing, withdrawing, and remitting money, so that the interactive relation between the customer and the bank is effectively improved and the bank's service quality is upgraded.

### BACKGROUND OF THE INVENTION

Conventionally, when a customer goes to a counter of a certain finance organization for a transaction, he or she has to fill some forms to provide necessary information or data for a counter clerk to handle and complete the transaction. There are times the customer provides incorrect handwriting information on the forms and has to rewrite new forms. This would result in waste of paper material and delayed completion of transaction.

On the other hand, the counter clerk is normally passively waiting in the counter until the customer comes to ask about information for a specific transaction, or delivers the completed forms to request for a certain type of transaction, and then executes related on-line computer transaction programs to complete the transaction.

### SUMMARY OF THE INVENTION

A primary object of the present invention is to improve the banking service quality by providing an interactive counter service system, so that a counter clerk may positively and actively assist in customer to complete a selected transaction.

The interactive counter service system for banks and similar finance organizations according to the present invention mainly includes a touch-screen module, a counter-terminal module, and network communicating equipment. The touch-screen module is mounted at counters of the banks to serve as an interface via which a customer may select one or more desired transactions provided by the bank by touching a touch screen, and input required data, such as a deposit book, a monetary card, or an IC smart card bearing the customer's personal information, via a magnetic strip reader or a card reader of the touch-screen module. The counter-terminal module enables a counter clerk to synchronously receive and process the data input by the customer and provide on-line business consultation to help the customer to complete the selected transaction. The customer needs not to fill any form or voucher, which is printed out by a printer and sent to the customer for his or her confirmation and signature or legal seal. Thereafter, the counter clerk may execute the computer on-line transaction program to complete the selected transaction.

The interactive counter service system effectively improves the interactive relation between the customer and the bank and thereby upgrades the service quality of the bank. Moreover, the interactive counter service system avoids incorrect handwriting information provided by the customer on the form and thereby eliminates unnecessary waste of paper material and delayed completion of the transaction.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of an interactive counter service system for banks and similar finance organizations according to an embodiment of the present invention; and

FIG. 2 is a flowchart showing the steps included in the interactive counter service system of FIG. 1 for a customer and a counter clerk to interactively complete a desired transaction.

### DETAILED DESCRIPTION OF THE PREFERRED EMBODIMENTS

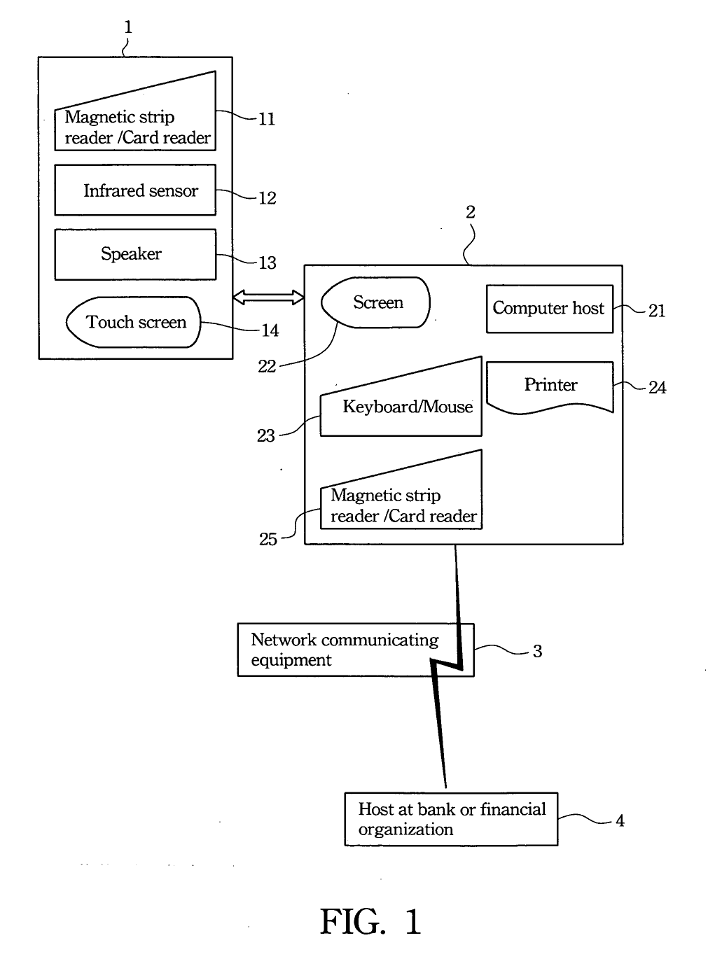

Please refer to FIG. 1 that is a block diagram of an interactive counter service system for banks and similar finance organizations according to an embodiment of the present invention. For simplicity, the interactive counter service system for banks and similar finance organizations of the present invention is referred to as “the System” hereinafter. As shown, the System includes a touch-screen module 1, on which a customer operates to proceed with a desired transaction, and a counter-terminal module 2, which is connected to the touch-screen module 1 to work on-line with the latter, and network communicating equipment 3 electrically connected to both the counter-terminal module 2 and a host 4 at the bank or the finance organization to work on-line with them.

The touch-screen module 1 includes a magnetic strip reader/card reader 11, an infrared sensor 12, a speaker 13, and a touch screen 14. The touch screen 14 further includes a liquid crystal display (LCD) and a touch panel (not shown). The counter-terminal module 2 is formed from an existing system of terminals and other on-line apparatuses in respective banks and finance organizations, and includes at least a computer host 21, a screen 22, a keyboard/mouse 23, a printer 24, and a magnetic strip reader/card reader 25. The network communicating equipment 3 provides local area network and Internet functions, and works on-line with a service host at the bank or the finance organization.

In the above embodiment, it is also possible for the touch-screen module 1 to use only one set of computer, including a screen, a host, a keyboard, a mouse, and other basic peripherals, to connect and send data to the counter-terminal module 2 via available network functions.

The touch-screen module 1 may be mounted at each counter window for use by customers, or independently located at a service counter in a lobby or a VIP room of the bank or finance organization for a counter clerk to provide the customer with one-to-one high quality service. The touch-screen module 1 may be vertically mounted on a top of the counter, horizontally mounted below the counter with the screen flashing with the top of the counter, slantingly mounted on the top of the counter, positioned against a wall on the counter, or rotatably mounted to two side walls of the counter, so that customers may easily access the module 1 for operation. The display for the touch-screen module 1 is a flat liquid crystal display, which is protected by a touch panel made of tempered glass.

On the liquid crystal display of the touch-screen module 1, there are shown various kinds of transactions provided by the bank or the finance organization, such as deposit, withdrawal, remittance, collection, check order, payment of bills for public utilities, registration of lost legal seal, alteration of password, trade of funds, safety deposit box, insurance, trust deposit, trade of foreign currencies, financial planning, open new account, issuance of deposit certificate, alteration and correction of customer information, and inquiry of personal account. The customer may touch the touch screen to select the desired transaction. There is also voicing prompt to assist the customer to complete various transactions.

The infrared sensor 12 of the touch-screen module 1 is adapted to sense any customer operating the touch screen 14. When there is not any customer using the touch screen 14, the liquid crystal display will automatically display related business information, interest rates, business regulations, announcements, governmental regulations and policies.

The magnetic strip reader/card reader 11 of the touch-screen module 1 allows a customer to independently read or provide personal account information via the magnetic strip on personal deposit book, monetary card, and IC smart card bearing personal identification.

The speaker 13 of the touch-screen module 1 provides voice service to assist the customer in operating the touch-screen module 1 for desired transactions.

When the customer touches the touch screen 14 to select one or more transactions, the screen 22 of the counter-terminal module 2 synchronously displays operating procedures entered by the customer at the touch screen 14. The counter-terminal module 2 may also operate other businesses at the same time. That is, data input by the customer at the touch screen 14 is synchronously received and processed by the counter-terminal module 2, and the counter clerk at the counter needs not to repeatedly input the customer's data. After the counter-terminal module 2 receives the customer data, the counter clerk at the counter may print out all related documents, evidences, and vouchers using the printer 24 and passes the same to the customer for his or her confirmation and signature or legal seal to complete the transaction.

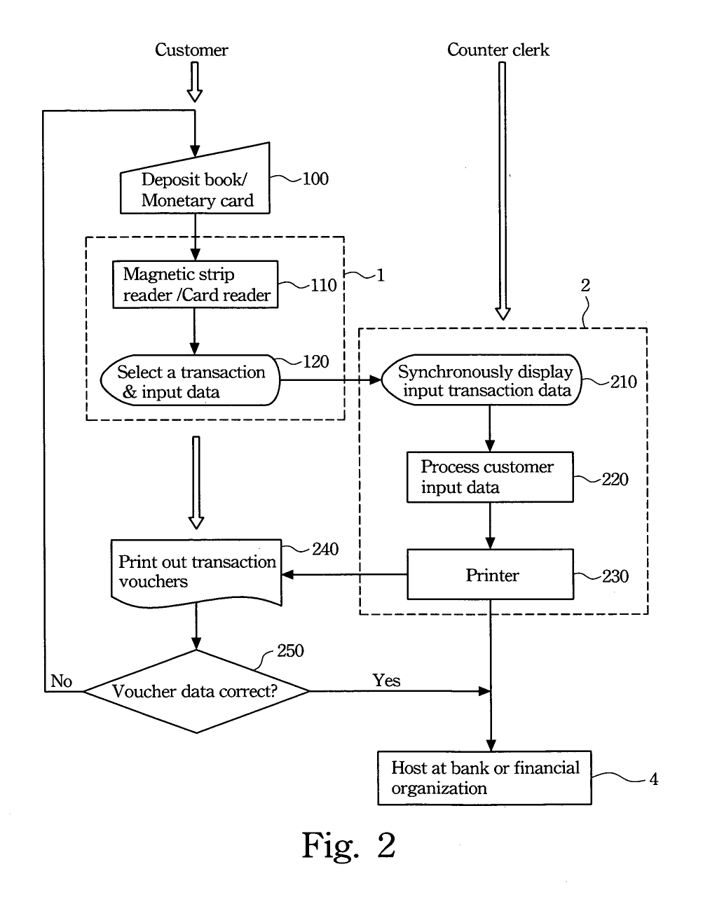

The operating steps included in the interactive counter service system of the present invention are now explained with reference to FIG. 2. Via the System, the customer and the counter clerk interact with each other to complete the desired transaction. Wherein, the customer selects a desired transaction, and the counter clerk provides business-related consultation and executes on-line service on computers to complete the transaction required by the customer.

First, the System is provided at one or more counter windows at the business lobby of the bank or similar finance organization. The customer prepares a specific deposit book, monetary card or IC smart card (step 100), and inputs account information using the magnetic strip reader/card reader 11 of the touch-screen module 1 (step 110) or selects a desired transaction and inputs necessary information directly on the touch screen 14 (step 120). At this point, the screen 22 of the counter-terminal module 2 synchronously displays the procedures operated by the customer (step 210), and processes the data input by the customer (step 220). The counter clerk will then send the data input by the customer to the printer 24 (step 230), and the printer 24 will print out related transaction vouchers and documents (step 240). The printouts are then passed to the customer for confirmation (step 250). The customer signs or puts a legal seal on the printouts if the printouts are correct, and the counter clerk finishes the on-line transaction.

1. An interactive counter service system for banks and similar finance organizations, comprising:
a touch-screen module including a touch screen, an infrared sensor, a magnetic strip reader/card reader, and a speaker; and said touch screen including a liquid crystal display and a touch panel;
a counter-terminal module including a host, a screen, a keyboard, a mouse, and a printer, and adapted to provide network functions to execute Windows; and
network communicating equipment capable of providing local area network (LAN) and Internet on-line functions, and being connected to and working on-line with a host at said banks or finance organizations;
said touch screen serving as an interface between a customer and a counter clerk for the customer to touch and select one of many transactions available from said touch-screen module; and said screen of said counter-terminal module being capable of synchronously displaying procedures operated by the customer, and allowing the counter clerk to provide the customer with related on-line business consultation via said screen.

2. The interactive counter service system for banks and similar finance organizations as claimed in claim 1, wherein said display of said touch-screen module is a flat type liquid crystal screen, and said touch panel is a tempered glass capable of protecting said liquid crystal screen.

3. The interactive counter service system for banks and similar finance organizations as claimed in claim 1, wherein said liquid crystal display of said touch-screen module is used to show various kinds of transactions provided by said banks or said finance organizations, such as deposit, withdrawal, remittance, collection, check order, payment of bills for public utilities, registration of lost legal seal, alteration of password, trade of funds, safety deposit box, insurance, trust deposit, trade of foreign currencies, financial planning, open new account, issuance of deposit certificate, alteration and correction of customer information, and inquiry of personal account information, and a customer may touch said touch screen to select a desired transaction; and wherein said touch screen of said touch-screen module also provides voicing prompt to assist the customer to complete various transactions.

4. The interactive counter service system for banks and similar finance organizations as claimed in claim 1, wherein said infrared sensor of said touch-screen module is adapted to sense any customer operating said touch screen, and said liquid crystal display automatically displays related business information, interest rates, business regulations, announcements, governmental regulations and policies when there is not any customer using said touch screen.

5. The interactive counter service system for banks and similar finance organizations as claimed in claim 1, wherein said magnetic strip reader/card reader of said touch-screen module allows a customer to independently read or provide personal account information via a magnetic strip on the customer's personal deposit book, monetary card, and IC smart card bearing personal identification.

6. The interactive counter service system for banks and similar finance organizations as claimed in claim 1, wherein said touch-screen module may be mounted in a manner selected from the group consisting of being vertically mounted on a top of a bank counter, horizontally mounted below a bank counter with said touch screen flashing with the top of the counter, slantingly mounted on the top of the counter, positioned against a wall on the counter, and rotatably mounted to two side walls of the counter; so that a customer may easily access said touch-screen module for operation.

7. The interactive counter service system for banks and similar finance organizations as claimed in claim 1, wherein said touch-screen module uses only one set of computer, including a screen, a host, a keyboard, a mouse, and other basic peripherals, to connect with said counter-terminal module via available network functions.

8. The interactive counter service system for banks and similar finance organizations as claimed in claim 1, wherein said touch-screen module may be mounted at each counter window for use by customers, or independently located at a service counter in a lobby or a VIP room of the banks or finance organizations for a counter clerk to provide the customer with one-to-one high quality service.

9. The interactive counter service system for banks and similar finance organizations as claimed in claim 1, wherein said screen of said counter-terminal module synchronously displays said operating procedures entered by the customer at said touch screen when the customer touches said touch screen to select one or more transactions, and wherein said counter-terminal module may also operate other businesses at the same time.

10. The interactive counter service system for banks and similar finance organizations as claimed in claim 9, wherein said data input by the customer at said touch screen is synchronously received and processed by said counter-terminal module, and the counter clerk at the counter needs not to repeatedly input said customer's data.

11. The interactive counter service system for banks and similar finance organizations as claimed in claim 10, wherein said printer of said counter-terminal module having received said customer data is adapted to print out via operation of the counter clerk all documents, evidences, and vouchers related to the selected transaction for passing to the customer for the customer's confirmation and signature or legal seal to complete one transaction at the counter.
